(19) United States
(12) Patent Application Publication
(10) Pub. No.: US 2013/0098220 A1
(43) Pub. Date: Apr. 25, 2013

(54) EXTERNAL BEAD SCARFER AND CHOPPER FOR PIPES AND TUBES

(71) Applicant: John Seminew, (US)

(72) Inventor: John Seminew, (US)

(21) Appl. No.: 13/278,413

(22) Filed: Oct. 21, 2011

(51) Int. Cl. B26D 3/00; B23K 7/06

(52) U.S. Cl. 83/861; 228/13

(57) ABSTRACT

A process and system for continuously removing an external weld bead from a moving pipe or tube that has been formed with a longitudinal weld seam extending along a longitudinal axis of the pipe or tube. An at least partially closed ribbon chamber receives scarfed ribbon on one end of the chamber, and a chopping device located adjacent the other end of the chamber chops the ribbon into pieces, before the ribbon pieces can jam or disrupt the continuous system flow.

### BACKGROUND OF THE INVENTION

The present invention generally relates to scarfing machines used to remove the longitudinal weld seam or “bead” on pipes and tubes. More specifically, the invention relates to scarfing and chopping machines for safely and efficiently removing the external or outside diameter bead on pipes and tubes.

Various types of pipes and tubes are manufactured using many different processes. Often, pipes and tubes are manufactured by welding sheet stock in a longitudinally continuous manner, resulting in a weld bead extending longitudinally along an external surface of the welded pipe or tube. Many applications require the removal of this external weld bead to provide a smoother outer surface of the pipe or tube.

Conventionally, a planing tool is placed in the travel path of the moving, welded pipe or tube, to contact its external surface and remove the external weld bead from the pipe in a continuous fashion. This process of continuously removing the weld bead from a moving pipe is known as “scarfing.” The removed weld bead is hot, sharp and stringy. As it is removed, the weld bead is extremely difficult to control, as it is often impossible to determine in which direction it will travel immediately after scarfing from the pipe or tube.

Pipe manufacturing systems have often initially manually attached this removed weld bead to a spool, and then automatically wound the bead on the spool during the welding and bead cutting process. But this process requires periodic interruption to change spools. It is also dangerous to operators, who are often cut and injured while attempting to manually wind the hot weld bead on the spool.

More recent pipe manufacturing processes have attempted to redirect the stringy removed weld beads or “ribbons” against the direction of travel of the welded pipe, feed them into a separate material-handling device opposite the scarfing/planing tool, and then chop them up using a rotary chopper. Prior art feeding mechanisms for guiding the scarfed weld bead into a separate material-handling device use rollers, chutes or other guides. U.S. Pat. No. 7,988,029 to Gleason discloses one system, in which the scarfed weld bead is fed downstream to a reciprocating chopper. The problem with the system disclosed in Gleason, as well as other prior feeding and chopping systems, is that because the removed weld bead/ribbon is so difficult to control, attempts to feed the ribbon to a remotely located chopper often result in jamming of the machine and temporary shut-down of the system. Operator safety issues are also involved, as well. Jamming issues are exacerbated when adjustments are made to bead removal systems, such as changing the speed of the pipe or tube, the type of material cut, etc.

Accordingly, there is a need for a scarfing and chopping machine that can safely and efficiently remove and dispose of the external weld bead from newly-formed pipes and tubes, and that can do so while minimizing jamming or other work stoppage.

### SUMMARY OF THE INVENTION

The objects mentioned above, as well as other objects, are solved by the present invention, which overcomes disadvantages of prior pipe manufacturing systems and machines used to remove external weld beads, while providing new advantages not believed associated with such systems and machines.

In one preferred embodiment, a process is disclosed for scarfing the external weld bead from a pipe or tube, and then chopping the removed bead. The process uses a planing tool with a cutting edge to continuously scarf the ribbon of external weld bead from the pipe or tube. Next, the weld bead is immediately chopped, without any need for providing a separate feed mechanism to feed the weld bead ribbon to a location separate from the scarfing location.

In a particularly preferred embodiment, a process is employed for removing an external weld bead from a pipe or tube that has been formed with a longitudinal weld seam extending along a longitudinal axis of the pipe or tube. In this preferred process, an at least partially closed ribbon chamber with sidewalls and lower and upper ends is provided. A scarfing device is located adjacent the lower end of the chamber, and a chopping device is located adjacent the upper end of the chamber. The scarfing device is used to scarf or remove the external weld bead from the pipe or tube in a continuous manner, to form a removed ribbon of weld bead which travels through the chamber. The ribbon emerging from the champer is periodically chopped into pieces. Preferably, the travel of the ribbon through the chamber may be facilitated in part by the presence of the sidewalls. In the preferred embodiment, the pipe or tube is moving continuously during scarfing and chopping, while the chamber, including the scarfing device, is stationary. The sidewalls of the chamber may be unbroken and continuous, or they may be discontinuous although it is preferable in this latter instance that the sidewalls sufficiently encircle a substantial portion of the perimeter of the chamber so as to retain the ribbon before chopping. In one embodiment, the chamber generally forms a horseshoe in cross-section.

One or more deflector shields (not shown) may be used to convey the chopped ribbon pieces away, such as to a storage bin. The scarfing device may include a carbide cutter, while the chopping device may have a cutting edge made of tool steel or carbide. The invention enables the ribbon to be chopped without the need for manual intervention. Typical mill speeds will have the pipe or tube traveling at between about 15-70 inches/second. The ribbon pieces may be cut into pieces which are less than about 1-foot in length, and more preferably between about 2-6 inches in length. Preferably, the steps of scarfing the external weld bead into a ribbon, and chopping the ribbon into pieces, take place in substantially parallel planes and closely adjacent to each other. Just prior to chopping, a longitudinal axis of the ribbon may preferably be oriented substantially parallel to a height of the guide chamber.

In a preferred embodiment, the chopping device includes a reciprocating arm, whose reciprocating movement pushes the chopped ribbon to either side of the arm and clear of the guide chamber and the scarfing device. Preferably, the arm has a sufficient height, such as about 1-2 inches, to enable the arm to easily push or “kick” the chopped ribbon pieces clear of the workspace.

An external weld bead removal system is also disclosed for removing weld bead from a pipe or tube that has been formed with a longitudinal weld seam extending along a longitudinal axis of the pipe or tube. The system preferably includes: a ribbon chamber with sidewalls; a scarfing device located adjacent one longitudinal end of the chamber; and a chopping device located adjacent an opposite longitudinal end of the chamber. The scarfing device scarfs and removes the external weld bead from the pipe or tube in a continuous manner, to form a removed ribbon of weld bead which travels through the chamber. The sidewalls of the chamber form an at least partially closed chamber. The chopping device periodically chops the ribbon into pieces as the ribbon travels through the chamber. The travel of the ribbon through the chamber may be facilitated in part by the presence of the sidewalls. Movement of the reciprocating arm may be driven by a pneumatic or hydraulic cylinder, and this movement preferably pushes or “kicks” the chopped ribbon pieces to either side of the guide chamber, free from jamming in the guide chamber or the scarfing device, and avoiding the need for manual intervention in this regard. Use of the invention also avoids the need to guide the ribbon from the scarfing location to the chopping location using either manual tools or guiding mechanisms.

### Definition of Claim Terms

The terms used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Scarf” means to continuously remove, by planing/cutting, an external weld bead from a pipe or tube that was formed by welding along a longitudinal seam. The removed weld bead forms a continuous ribbon of weld bead.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a front perspective view of a preferred embodiment of the external pipe bead scarfing and chopping machine of the present invention;

FIG. 2 is a top view of the preferred embodiment shown in FIG. 1; and

FIGS. 3A and 3B are planar perspective views of a left-side portion of the preferred embodiment shown in FIGS. 1-2, illustrating the chopper arm movement.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

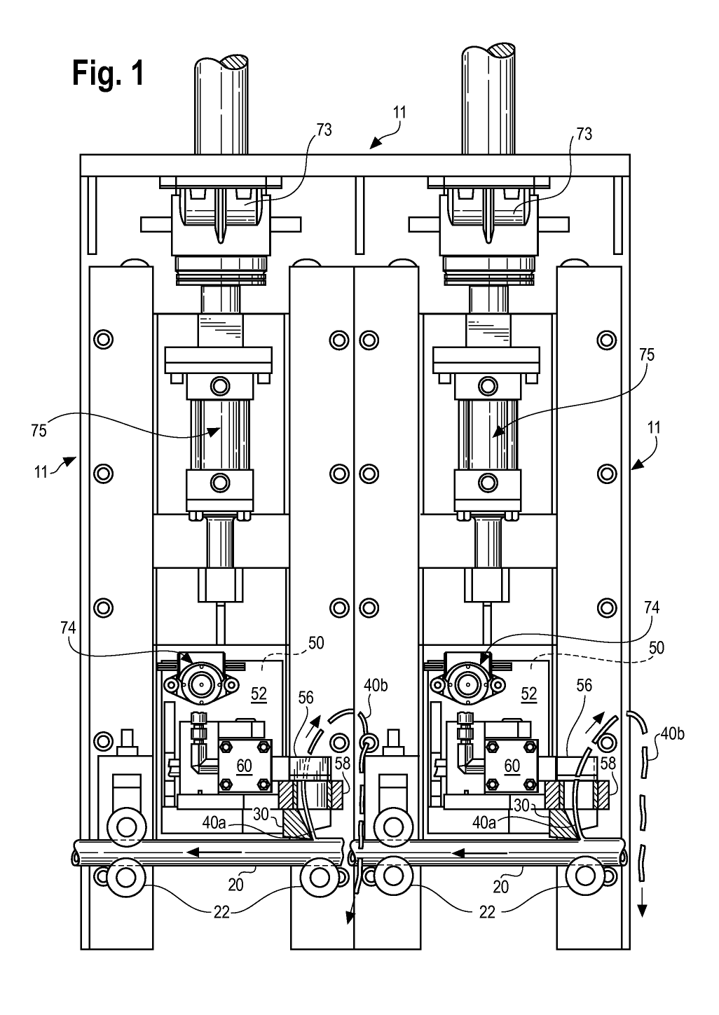

Referring first to FIG. 1, a preferred embodiment of the external pipe bead scarfing and chopping machine of the present invention is designated generally with the reference numeral 10. Pipe 20 may be driven by forming fin and sizing sections of a mill (not shown) using guiding mechanisms such as rollers 22, as is well known in the art, in the direction of the arrows shown. During its continuous travel, scarfing/chopping machine 10 first removes the external weld bead or “ribbon” of the pipe, using scarfing cutter 30, and then chops the continuous-length ribbon 40a into pieces 40b of a desired length using a reciprocating cutter, such as arm 56.

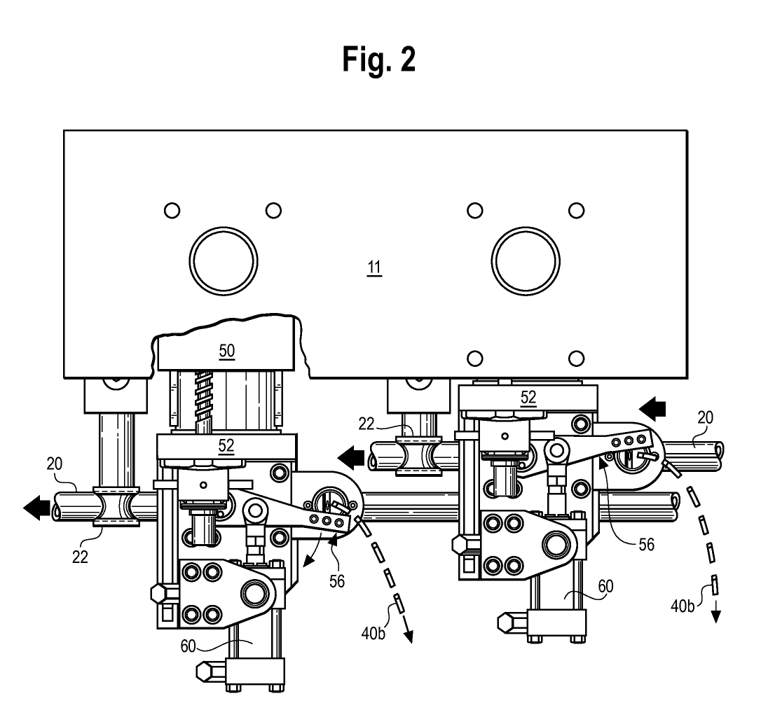

Still referring to FIG. 1, the scarfing and chopping assembly is supported by mounting plate 11, and includes a vertical slide assembly 50 and a horizontal slide assembly 52. As is well known by tube mill developers and operators, vertical slide assembly 50 may be moved vertically up and down using main jack 73, which may be a screw jack (see, e.g., 50a, FIG. 2). This allows adjustment of the cutting tool for pipe size and the depth of scarf cut. A quick-lift hydraulic cylinder 75 may also be used to quickly lift the tool out of a cut to prevent damage. Horizontal slide assembly 52 may be moved horizontally in and out relative to the mounting plate, such as by using a small jack 74. This allows adjustment of the cutting tool across the centerline of the mill.

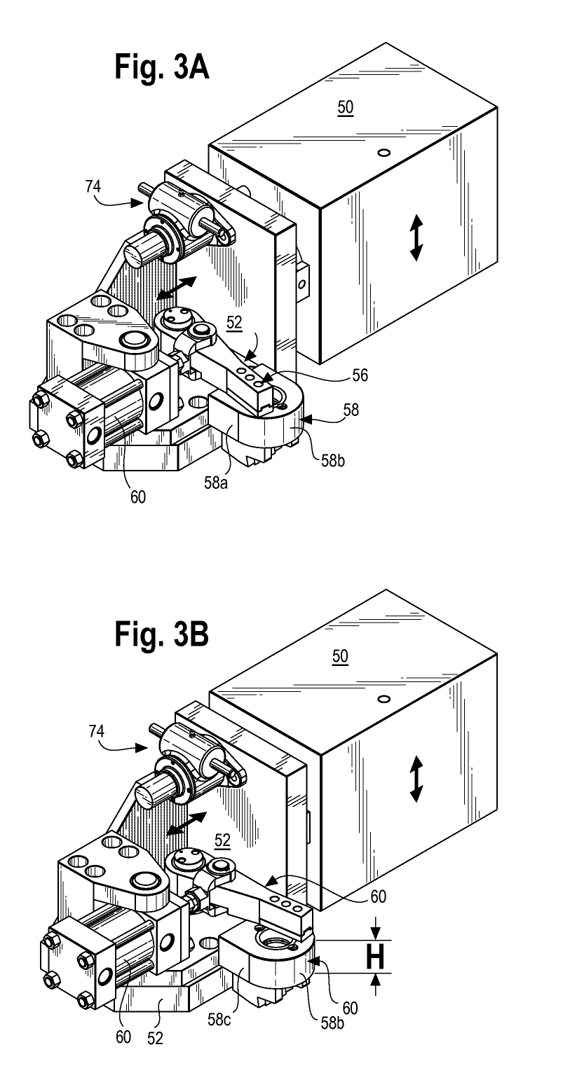

Scarfing machines for removing the external weld bead of a pipe are well known, such as that disclosed in U.S. Pat. No. 7,988,029, incorporated by reference herein for this purpose. It is typically desired to use a carbide cutting tool for the scarfing cut/bead removal. Rotary chopping machines are also known, although the reciprocating chopper disclosed here is preferred because it provides the ability to continuously chop a moving ribbon, cutting in both directions and kicking chopped pieces clear of the workspace, and because the speed of the reciprocating cutting arm may be easily varied, using (e.g.) a hydraulic or pneumatic cylinder 60 (FIG. 3). For example, one preferred rotary chopping speed is about 1 ribbon cut/second which, for a typical ribbon travel speed of about 5 inches/second (accounting for pipe speed and tool compression effects), results in a chopped ribbon length of roughly 4-5 inches. The chopping speed may be easily varied to result in shorter or longer ribbon piece lengths.

Preferably, the ribbon chopper is a tool steel cutter (e.g., S7 or M2), instead of carbide, as it has been found that chopping delivers a shock load better absorbed by tool steel. The choice of cutting material can be an important consideration when it is understood that coated carbide scarfing cutters must be replaced every few hours, given the harsh application, which results in processing down-time.

Testing has shown that a guide chamber 58 height “H” (FIG. 3B) of about two inches may be optimal: this height has been found sufficient to “kick” the cut ribbon pieces in one direction or the other, so that they may be discharged clear of the work area, and (e.g.) discharged by a conveyor into a scrap hopper. Substantially larger heights may require operator intervention due to potential jamming of the ribbon within the guide chamber, as the ribbon can fold onto itself An arm height of about 1 and ½ inches has been found to be preferred. Preferably the arm has a sufficient height to ensure that it will effectively sweep the cut ribbon pieces clear of the guide chamber and the scarfer.

Referring to FIGS. 3A and 3B, guide chamber 58 is illustrated in a generally “horseshoe” configuration with planar sidewalls 58a, curved end sidewall 58b, and a planar end 58c. Planar end 58c may even have an open end (i.e., a true horseshoe shape). Guide chamber 58 may also take other geometric configurations, such as polygonal shapes like circular, square, elliptical or rectangular, as desired and given the application. Round configurations may be preferred, as corners can be potential areas where cut ribbon pieces can jam.

Importantly, the guide chamber is designed to receive the continuously-scarfed bead/ribbon, and to immediately guide/allow the ribbon to travel through the guide chamber and enable the ribbon to be cut when the ribbon's length is substantially parallel to the guide chamber height Fl and substantially perpendicular to the length of chopping arm 56. For this purpose, the guide chamber should have open top and bottom ends, but substantially enclosed sidewalls to keep the ribbon from escaping.

It will be understood by those of ordinary skill in the art that while the preferred embodiment machine shown in the drawings shows the pipe as traveling in a horizontal plane, and the ribbon traveling in a vertical plane, a machine and/or process may be easily designed in which the pipe travels vertically and the ribbon travels horizontally, for example.

After the ribbon is scarfed and chopped, it may be removed using deflector shields and/or conveying mechanisms to a scrap container, for example.

The present invention may be adapted for use by those of ordinary skill in the art to scarf and chop the external weld bead of virtually any longitudinally-welded pipe or tube, in a continuous fashion as the pipe or tube moves through the machine.

While the preferred embodiment shown in the drawings shows a dual or tandem scarfing and cutting units, it will of course be appreciated that single scarfing and cutting units, or more than two, may be used as desired.

The above description is not intended to limit the meaning of the words used in the following claims that define the invention. Persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

I claim:

1. A process for removing an external weld bead from a pipe or tube that has been formed with a longitudinal weld seam extending along a longitudinal axis of the pipe or tube, comprising the steps of:
providing an at least partially closed ribbon chamber with sidewalls and lower and upper ends, a scarfing device adjacent the lower end of the chamber, and a chopping device adjacent the upper end of the chamber, s;
using the scarfing device to scarf the external weld bead from the pipe or tube in a continuous manner, to form a removed ribbon of weld bead which travels through the chamber; and
periodically chopping the ribbon into pieces as the ribbon travels through the chamber.

2. The process of claim 1, wherein the travel of the ribbon through the chamber is facilitated in part by the presence of the sidewalls.

3. The process of claim 1, wherein the pipe or tube is moving continuously during scarfing and chopping, and the chamber, including the scarfing device, is stationary.

4. The process of claim 1, wherein the sidewalls of the chamber are unbroken and continuous.

5. The process of claim 1, wherein the sidewalls of the chamber are discontinuous.

6. The process of claim 1, wherein the chamber generally forms a horseshoe in cross-section.

7. The process of claim 1, further comprising one or more deflector shields for use in conveying the chopped ribbon pieces to a storage bin.

8. The process of claim 1, wherein the scarfing device comprises a carbide cutter.

9. The process of claim 1, wherein the chopping device has a cutting edge made of tool steel or carbide.

10. The process of claim 1, wherein the ribbon is chopped without the need for manual intervention.

11. The process of claim 3, wherein the pipe or tube is moving at between about 15-70 inches/second

12. The process of claim 1, wherein the ribbon is cut into pieces which are less than about 1-foot in length.

13. The process of claim 12, wherein the ribbon is cut into pieces which are between about 2-6 inches in length.

14. The process of claim 1, wherein the steps of scarfing the external weld bead into a ribbon, and chopping the ribbon into pieces, take place in substantially parallel planes and closely adjacent to each other.

15. The process of claim 1, wherein just prior to chopping, a longitudinal axis of the ribbon is oriented substantially parallel to a height of the guide chamber.

16. The process of claim 1, wherein the chopping device comprises a reciprocating arm, and further comprising the step of the reciprocating movement of the arm pushing the chopped ribbon pieces clear of the guide chamber and the scarfing device.

17. A external weld bead removal system for removing weld bead from a pipe or tube that has been formed with a longitudinal weld seam extending along a longitudinal axis of the pipe or tube, comprising:
a ribbon chamber with sidewalls;
a scarfing device located adjacent one longitudinal end of the chamber;
a chopping device located adjacent an opposite longitudinal end of the chamber;
wherein the scarfing device scarfs and removes the external weld bead from the pipe or tube in a continuous manner, to form a removed ribbon of weld bead which travels through the chamber;
wherein the sidewalls of the chamber form an at least partially closed chamber; and
wherein the chopping device periodically chops the ribbon into pieces as the ribbon travels through the chamber.

18. The external weld bead removal system of claim 17, wherein the travel of the ribbon through the chamber is facilitated in part by the presence of the sidewalls

19. The external weld bead removal system of claim 17, wherein the chopping device has a cutting edge made of tool steel.

20. The external weld bead removal system of claim 17, wherein the chopping device comprises a reciprocating arm.

21. The external weld bead removal system of claim 20, wherein a reciprocating movement of the arm pushes the chopped ribbon pieces to either side of the guide chamber and clear of the guide chamber and the scarfing device.

22. The external weld bead removal system of claim 17, wherein movement of the reciprocating arm is driven by one or more hydraulic cylinders.

23. The external weld bead removal system of claim 17, wherein the ribbon is chopped following scarfing without the need for manual intervention.

24. The external weld bead removal system of claim 17, wherein the ribbon is chopped following scarfing without the need to guide the ribbon from the scarfing location to the chopping location using manual tools or guiding mechanisms.
